(19) United States
(12) Patent Application Publication
(10) Pub. No.: US 2019/0042952 A1
(43) Pub. Date: Feb. 7, 2019

(54) Multi-task Semi-Supervised Online Sequential Extreme Learning Method for Emotion Judgment of User

(71) Applicant: Beijing University of Technology, Beijing (CN)

(72) Inventors: Xibin JIA, Beijing (CN); Xinyuan CHEN, Beijing (CN)

(21) Appl. No.: 15/668,570

(22) Filed: Aug. 3, 2017

(51) Int. Cl. G06N 5/02; G06K 9/62; G06N 99/00

(52) U.S. Cl. CPC G06N 5/025; G06N 99/005; G06K 9/6263; G06K 9/6257

(57) ABSTRACT

It discloses multi-task semi-supervised online sequential extreme learning method for emotion recognition of user, including establishing multiple channels at input layer and hidden layer based on semi-supervised online sequential extreme learning machine, including main-task channel for treating emotion main task, multiple sub-task channels for processing multiple emotion recognition sub-task, establishing multi-task semi-supervised online sequential extreme learning algorithm; establishing multi-layer stack self-coding extreme learning network in each channel; performing facial expression image feature extraction on user's expression, and inputting extracted feature vector to main-task channel and corresponding sub-task channel; connecting each output node and all hidden layers nodes on output layer, calculating output, output node being set to T, T=[t₁, t₂], t₁=1, t₂=0, expressing positive emotions, t₁=0, t₂=1, expressing negative emotions.

### TECHNICAL FIELD

The present invention belongs to the field of machine learning and pattern recognition, and is mainly suitable for personal emotion judgment, natural expression recognition, etc., in particular to a multi-task semi-supervised online sequential extreme learning method for emotion judgment of user.

### BACKGROUND

The present invention relates to a disclosed algorithm-Semi-Supervised Online Sequential Extreme Learning Machine (SOS-ELM). The algorithm has the characteristics of online learning, and supporting semi-supervised input data. Online learning is that the algorithm can be used to increased training data for extreme learning of recognition model after completing initial training process, thus continuing to improve recognition rate. The semi-supervision means that the algorithm also supports both labeled and unlabeled training data to achieve use of unlabeled data. The recognition effect of unlabeled data after training is better than using only labeled data training. However, the SOS-ELM is still a shallow machine learning algorithm, depending on identifiable feature extraction, coupling with diversity of natural people's emotional state, and the SOS-ELM has still big difference to achieve intelligent service robot on judgment of natural people's emotional state. Therefore, how to timely detect the negative emotions of users, and to provide a basis for further intelligent services, is currently being explored important issue.

### DESCRIPTION

A purpose of the present invention is to solve at least above problems and to provide at least the advantages that will be described later.

Another purpose of the present invention is to provide a multi-task semi-supervised online sequential extreme learning method for emotion judgment of user.

The technical solution provided by the invention is:

A multi-task semi-supervised online sequential extreme learning method for emotion judgment of user, including:

Based on the semi-supervised online sequential extreme learning machine, establishing a plurality of channels at an input layer and a hidden layer, the plurality of channels including a main task channel for treating emotion main task, a plurality of sub-task channels for processing each plurality of emotion recognition sub-task, establishing multi-task semi-supervised online sequential extreme learning algorithm.

Establishing multi-layer stack self-coding extreme learning network in each channel;

Performing feature extraction of facial expression image on the user's expression, and inputting extracted feature vector of facial expression image to the main task channel and the corresponding sub-task channel;

Connecting each output node and all hidden layers nodes on the output layer, calculating output, and determining the user's emotion, wherein the output node is set to T, T=[t₁, t₂], wherein: t₁=1, t₂=0, express positive emotions, and t₁=0, t₂=1, express negative emotions.

Preferably, the multi-task semi-supervised online sequential extreme learning method for emotion judgment of user, wherein the specific calculation process of the multi-task semi-supervised online sequential extreme learning algorithm includes the following steps:

1) defining parameter of the multi-task semi-supervised online sequential extreme learning algorithm:

p: the number of channels, wherein the channel 1 is main task channel, and the remaining 2 . . . p are sub-task channels, representing state number of positive emotions and the negative emotions;

Xₖ=[X_{k,1}, . . . , X_{k,N}]: the input vector of the k-th channel, k=1,2, . . . , p;

N: the vector dimension of input data or test data.

T=[t₁, t₂]: the output vector expressing judgment results of positive emotions and negative emotions. Wherein: t₁=1, t₂=0, express positive emotions, and t₁=0, t₂=1, express negative emotions, for multi-task problem of a variety of emotional recognition, being equivalent to output plus bias, for labeled training data, output of positive emotions being t₁+Δtᵣ; output of negative emotions being t₁+Δt_{w}; and for unlabeled training data, t₁ being filled with 0;

Hₖ=[H_{k,1} . . . H_{k,Ñ}]: the output of the hidden layer on the k-th channel, k=1,2, . . . , p;

Ñ: the hidden nodes number of the k-th channel;

2) multi-task semi-supervised online sequential extreme learning network structure and multi-task parameter training method based on multi-channel, performing continuous training and calculation to obtain the output parameters β=H^{†}T using multi-layer contraction self-coding extreme network;

3) according to the method in the step 2), using semi-supervised online learning method in the parameter training process, performing the training data in batches, and containing labeled training data and unlabeled training data in each batch of training samples;

3.1) the training process of the multi-task semi-supervised sequential extreme learning algorithm:

According to the SOS-ELM algorithm, the output parameter training process and the calculation method based on the continuity and hypotheticality of data, the simplest optimization target of function, and matrix block calculation method, are as follows:

(I) inputting an initial training data block κ₀:

The initial training data block κ₀={(xᵢ,tᵢ+Δtᵢ) or x′ᵢ}ᵢ₌₁^{N}^{₀}, wherein N₀ is the number of samples; xᵢ is labeled samples, which corresponding emotional label is positive and negative emotional sub-category label tᵢ plus the emotional bias Δtᵢ; and x′ᵢ is unlabeled samples, which corresponding label tᵢ is 0.

Initializing the input of the multi-channel, performing assignment in the corresponding sub-task channel according to the emotional label of each sample, if the i-th sample belongs to emotional sub-task of the k-th channel, xₖ=xᵢ, while the input of the main task channel 1 is set to x₁=λxᵢ the input of the remaining channel is 0, and the emotional expression is tᵢ+Δtᵢ. For unlabeled date, assigning only in the main task channel, setting the input of the remaining channel to 0, and reconstructing the initial training data block κ₀={(λxᵢ . . . 0 . . . xᵢ . . . 0,tᵢ+Δtᵢ) or x′ᵢ . . . 0 . . . 0}ᵢ₌₁^{N}^{₀};

(II) parameter initialization

Calculating initial output parameter β⁽⁰⁾ in the initial training data block

β⁽⁰⁾=K₀⁻¹H₀^{T}J₀T₀

Wherein K₀=I+H₀^{T}J₀H₀L_{κ}_{₀}H₀

Wherein I is regularization matrix.

T₀ is N₀×2 label matrix.

$${T}_{0} = [ \begin{matrix}… & … \\ ( {t}_{i} + Δ {t}_{i )} & 0 \\ … & …\end{matrix} ] ;$$

J₀ is diagonal matrix of N₀×N₀, wherein the element value of the diagonal matrix is set to the empirical parameter Cᵢ at the corresponding position having label data, otherwise 0; which is used to adjust the matrix of unbalanced training sample problem;

H₀ is the output matrix of (p*feature vector dimension)×N₀ hidden layer, merging the output of the hidden layer of all p channels. For multi-task problem, N₀ samples correspond to the depth feature of the sub-channels calculation in the initial training data block, taking the i-th sample belonging to emotional sub-task of the k-th channel as an example, setting corresponding component H₀^{k}=β_{k,3}β_{k,2}β_{k,1}xᵢ^{T}, while setting component of the main task channel of H₀¹=λβ_{k,3}β_{k,2}β_{k,1}xᵢ^{T}, and the remaining channel of 0 vector,

Thus,

$${H}_{0} = {[ \begin{matrix}… & … & … & & \\ λ {β}_{k , 3} {β}_{k , 2} {β}_{k , 1} {x}_{i}^{T} & 0 & … {β}_{k , 3} {β}_{k , 2} {β}_{k , 1} {x}_{i}^{T} & … & 0 \\ … & … & … & & \end{matrix} ]}^{T} ;$$

L_{κ}_{₀} is N₀×N₀ Laplacian matrix for solving semi-supervised learning calculation problem, using adjacent data smoothness constraints as optimization targets for achieving unlabeled data to participate in the calculation of the classification surface. The calculation formula is L_{κ}_{₀}=D−W, wherein D is diagonal matrix, which element is Dᵢᵢ=Σⱼ₌₁^{m}Wᵢⱼ, Wᵢⱼ=e^{-∥x}^{ᵢ}^{-x}^{ⱼ}^{∥}^{²}^{/2δ}^{²}, xᵢ is a sample vector, and δ is an empirical value;

(III) performing iterative calculation of output matrix

When new training data block κₖ is added, performing iterative calculation of output matrix β^{(k+1)}.

β^{(k+1)}=β^{(k)}+Pₖ₊₁Hₖ₊₁^{T}[Jₖ₊₁Tₖ₊₁−(Jₖ₊₁+λL_{κ}_{ₖ₊ₛ})Hₖ₊₁β^{(k)}]

Wherein

Pₖ₊₁=Pₖ−PₖHₖ₊₁^{T}(I+(Jₖ₊₁+λL_{κ}_{ₖ₊ₛ})Hₖ₊₁PₖHₖ₊₁^{T})⁻¹

3.2) Recognition process of the multi-task semi-supervised sequential extreme learning algorithm:

Calculating the depth feature of data to be identified x in the main task channel to obtain the output matrix H¹=λβ_{1,3}β_{1,2}β_{1,1}x^{T} of the hidden layer of the main task channel. At this time, doing not consider specific emotional bias, and thus the feature vector of the remaining channel is 0, stitching together H^{k} of other sub-task channels as the output matrix H of the hidden layer, calculating category label \hat{T}=βH of x according to obtained β in the training phase to achieve judgment of the emotional polarity.

Preferably, the multi-task semi-supervised online sequential extreme learning method for emotion judgment of user, in the step 2), the multi-layer contraction self-coding extreme network structure and multi-task parameter training method based on multi-channel specifically includes that:

the multi-task semi-supervised online sequential extreme learning network structure is mixed neural network, containing the input layer, the hidden layer and the output layer;

Wherein the input layer is independent input of multi-channel, including a main task channel and p−1 sub-task channels, wherein each channel uses the output parameter β=[β₁₁ . . . βᵢⱼ . . . β_{MN}] of each layer of a published multi-layer contraction self-coding extreme network to represent the weight of the connection node between two layers;

According to the contraction self-coding mechanism, the coding layer: H=G(αX+b), wherein αᵢⱼ is the element of the vector α, that is, the weight of the connection between the input layer node i and the feature layer node j, bⱼ is the element of the vector b, that is, the bias of the feature layer node; and G is a stimulus function using the sigmoid function

$$G ( z ) = \frac{1}{1 + {e}^{- z}} ,$$

x to input the vector for each layer;

According to the extreme learning machine mechanism, wherein α and b are random numbers meeting optimization target condition of contraction coding, calculating the parameter β, as shown in the following formula, namely: decoding the minimum error of the predicted value Hβ and the actual value X, and first order continuity of transfer function;

β=argmin(∥Hβ−X∥₂²+λ∥J_{f}(x)∥_{F}²)

Wherein J_{f}(x) is Jacobian matrix of the transfer function of the feature layer, which calculation method is shown as follows:

$${‖ {J}_{f} ( X ) ‖}_{F}^{2} = {\sum }_{ij}^{ } {( \frac{\partial {\sum }_{k = 1}^{L} {G}_{k} ( X , {a}_{k} , {b}_{k} ) {β}_{kj}}{\partial {x}_{i}} )}^{2} ;$$

The coding layer parameters β can be obtained according to symmetry hypothesis of the coding layer and the decoding layer, and the output parameters β are calculated for each hidden layer for realizing deep feature extraction of input data of the channel as the input of the hidden layer in the multi-task semi-supervised online sequential extreme learning algorithm;

The hidden layer is used to connect output results of multi-channel and as input of the output layer, assuming that the k-th channel adopts the three-layer hidden layer feature extraction network (the output parameter of each layer is recorded as β_{k,1},β_{k,2},β_{k,3}), the transfer function of the hidden layer of the multi-layer contraction self-coding extreme network is Hₖ=β_{k,3}β_{k,2}β_{k,1}X^{T};

The output layer is used to connect the output of the hidden layer of each channel to the output layer, which output transmission parameters are recorded as β in the multi-task semi-supervised online sequential extreme learning algorithm. The elements βᵢⱼ indicates the weight of the connection between the hidden layer node i and the output layer node j, calculating the output parameter β=H^{†}T through calculation results H of the hidden layer and sample T according to estimated minimum error and network weight regularization optimization target.

Preferably, the multi-task semi-supervised online sequential extreme learning method for emotion judgment of user, wherein, in the multi-task semi-supervised online sequential extreme learning method, one sub-task channel is only inputted one training sample data at a time, and the input of the remaining sub-task channels takes a value of 0, assuming that the input of the k-th sub-task is xₖ, thus the input of the main task channel is x₁=λxₖ, wherein λ is the penalty factor of the sub-task, and is in the range of (0,1).

Preferably, the multi-task semi-supervised online sequential extreme learning method for emotion judgment of user, wherein the hidden layer nodes of each channel can be adjusted.

The present invention includes at least the following effects:

The present invention applies the depth extreme learning network to the depth feature extraction of the facial image based on the data learning, and introduces the multi-task learning mechanism of the emotion state judgment and the multiple emotion recognition, improving emotion state judgment ability of natural person, reducing the influence of emotion diversity of the natural person's to emotion judgment, capable of realizing the judgment of the emotional state of the service object by collecting the facial video of the service object on intelligent service robot visual computing system, discovering timely the negative emotion of the user and providing the basis for further intelligent service.

The present invention is particularly applicable to polarity recognition of personal emotion. The multi-task semi-supervised online sequential extreme learning method of the present invention does not only inherit advantages of the original online learning of the SOS-ELM algorithm and support of semi-supervised training data, but also integrates into the depth feature extraction method, increases process ability of multi-channel input, establishes multi-task learning mechanism, effectively overcomes the influence of emotional diversity on the judgment of emotional polarity in terms of emotional polarity recognition, and improves the judgment ability of emotional polarity.

The present inventive method supports sequential learning, supports semi-supervised training samples, and has extremely fast training speed. The method is applied to the intelligent service robot to judge the user's emotional state, which can achieve higher recognition rate in the case of less training samples, and occupy less processor and memory resources. The algorithm is suitable for solving the problem that the labeled sample is insufficient, and the multi-source information fusion machine can be obtained in batches of labeled samples and unlabeled samples.

Other advantages, objects, and features of the invention will be showed in part through following description, and in part will be understood by those skilled in the art from study and practice of the invention.

### BRIEF DESCRIPTION OF THE DRAWINGS

FIG. 1 is a neural network model view of the semi-supervised extreme learning according to the present invention;

FIG. 2 is a neural network model view of the multi-task semi-supervised sequential extreme learning according to the present invention;

FIG. 3 is a view of the depth contraction self-coding extreme network structure and training process according to the present invention.

### DETAILED DESCRIPTION

The present invention will now be described in further detail with reference to the accompanying drawings as required.

It is to be understood that terms of “having”, “containing” and “including” as used herein do not exclude presence or addition of one or more other elements or combinations thereof.

The present invention applies the depth extreme learning network to the depth feature extraction of the facial image based on the data learning, and introduces the multi-task learning mechanism of the emotion state judgment and the multiple emotion recognition, improving emotion state judgment ability of natural person, reducing the influence of emotion diversity of the natural person's to emotion judgment, capable of realizing the judgment of the emotional state of the service object by collecting the facial video of the service object on intelligent service robot visual computing system, discovering timely the negative emotion of the user and providing the basis for the further intelligent service.

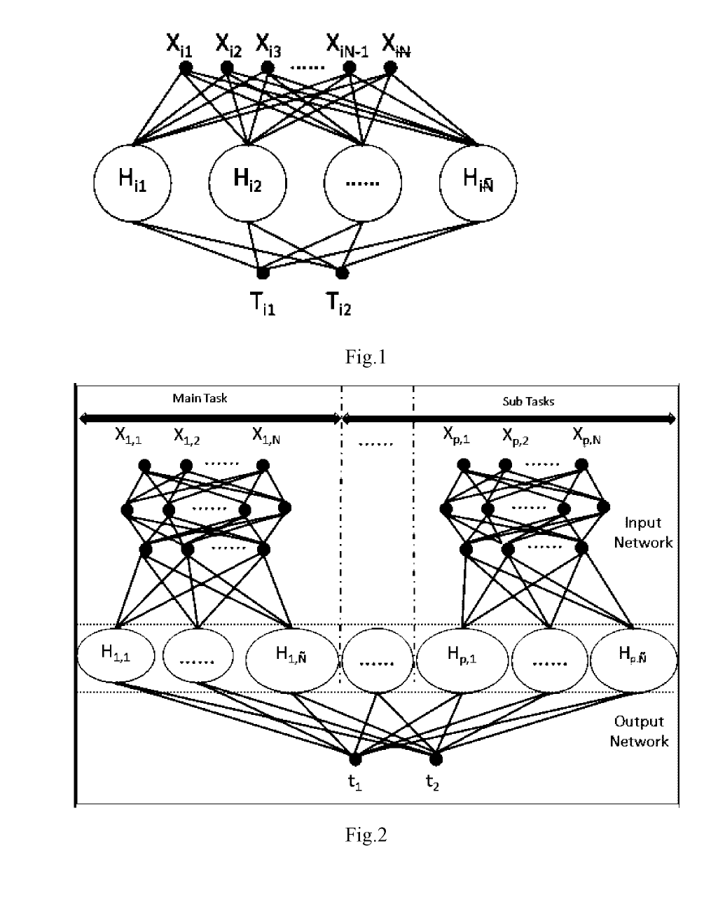

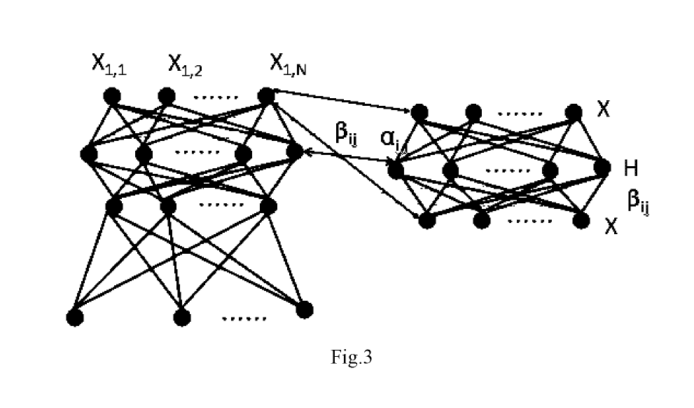

As shown in FIG. 2-3, the present invention provides a multi-task semi-supervised online sequential extreme learning method for emotion judgment of user, including:

Based on the semi-supervised online sequential extreme learning machine, establishing a plurality of channels at an input layer and a hidden layer, the plurality of channels including a main task channel for treating emotion main task, a plurality of sub-task channels for processing each plurality of emotion recognition sub-task, establishing multi-task semi-supervised online sequential extreme learning algorithm Random vector a and random number b generated of different sub-tasks in the algorithm initialization are not the same. Each sub-task channel corresponds to a sub-task, inputting vector while inputting its corresponding sub-task channel. For example, happy, sad and other emotions can be considered sub-tasks. Each emotion has its corresponding channel, inputting vector for the training data while inputting its corresponding channel.

Establishing multi-layer stack self-coding extreme learning network in each channel;

Performing feature extraction of facial expression image on the user's expression, and inputting extracted feature vector of facial expression image to the main task channel and the corresponding sub-task channel;

Connecting each output node and all hidden layers nodes on the output layer, calculating output, and determining the user's emotion, wherein the output node is set to T, T=[t₁, t₂], wherein: t₁=1, t₂=0, express positive emotions, and t₁=0, t₂=1, express negative emotions. When the output is calculated, each output node and all hidden layers nodes of all channels are connected for obtaining all dates and accurately determining the user's emotions.

In one embodiment of the present invention, in the multi-task semi-supervised online sequential extreme learning method for emotion judgment of user, it is preferred that the specific calculation process of the multi-task semi-supervised online sequential extreme learning algorithm includes the following steps:

1) defining parameter of the multi-task semi-supervised online sequential extreme learning algorithm:

p: the number of channels, wherein channel 1 is a main task channel, and the remaining 2 . . . p are sub-task channels, representing state number of positive emotions and the negative emotions;

Xₖ=[X_{k,1}, . . . , X_{k,N}]: the input vector of the k-th channel, k=1,2, . . . , p;

N: the vector dimension of input data or test data.

T=[t₁, t₂]: the output vector expressing judgment results of positive emotions and negative emotions. Wherein: t₁=1, t₂=0, express positive emotions, and t₁=0, t₂=1, express negative emotions. For multi-task problem of a variety of emotional recognition, being equivalent to output plus bias. For labeled training data, the output of positive emotions is t₁+Δtᵣ; and the output of negative emotions is t₁+Δt_{w}. For unlabeled training data, tᵢ is filled with 0.

Hₖ=[H_{k,1} . . . H_{k,Ñ}]: the output of the hidden layer on the k-th channel, where k=1,2, . . . , p.

Ñ: hidden nodes number of the k-th channel.

2) the multi-task semi-supervised online sequential extreme learning network structure and multi-task parameter training method based on multi-channel, performing continuous training and calculation to obtain the output parameters β=H^{†}T using a multi-layer contraction self-coding extreme network;

3) according to the method in the step 2), performing the training data in batches using semi-supervised online learning method in the parameter training process, and containing labeled training data and unlabeled training data in each batch of training samples;

3.1) the training process of the multi-task semi-supervised sequential extreme learning algorithm:

According to the SOS-ELM algorithm, the output parameter training process and the calculation method based on the continuity and hypotheticality of data, the simplest optimization target of function, and matrix block calculation method, are as follows:

(I) inputting initial training data block κ₀:

The initial training data block κ₀={(xᵢ,tᵢ+Δtᵢ) or x′ᵢ}ᵢ₌₁^{N}^{₀}, wherein N₀ is the number of samples; xᵢ is labeled samples, which corresponding emotional label is positive and negative emotional sub-category label tᵢ plus the emotional bias Δtᵢ; and x′ᵢ is unlabeled samples, which corresponding label tᵢ is 0.

Initializing the input of the multi-channel, performing assignment in the corresponding sub-task channel according to the emotional label of each sample, if the i-th sample belongs to emotional sub-task of the k-th channel, xₖ=xᵢ, while the input of the main task channel 1 is set to x₁=λxᵢ, the input of the remaining channel is 0, and the emotional expression is tᵢ+Δtᵢ. For unlabeled date, assigning only in the main task channel, setting the input of the remaining channel to 0, and reconstructing the initial training data block

κ₀={(λxᵢ . . . 0 . . . xᵢ . . . 0,tᵢ+Δtᵢ) or x′ᵢ . . . 0 . . . 0}ᵢ₌₁^{N}^{₀};

(II) parameter initialization

Calculating initial output parameter β⁽⁰⁾ in the initial training data block

β⁽⁰⁾=K₀⁻¹H₀^{T}J₀T₀

Wherein K₀=I+H₀^{T}J₀H₀L_{κ}_{₀}H₀;

Wherein I is regularization matrix.

T₀ is N₀×2 label matrix.

$${T}_{0} = [ \begin{matrix}… & … \\ ( {t}_{i} + Δ {t}_{i )} & 0 \\ … & …\end{matrix} ] ;$$

J₀ is diagonal matrix of N₀×N₀, wherein the element value of the diagonal matrix is set to the empirical parameter Cᵢ at the corresponding position having label data, otherwise 0; which is used to adjust the matrix of unbalanced training sample problem;

H₀ is the output matrix of (p*feature vector dimension)×N₀ hidden layer, merging all output of the hidden layer of p channels. For multi-task problem, N₀ samples correspond to the depth feature of the sub-channels calculation in the initial training data block, taking the i-th sample belonging to emotional sub-task of the k-th channel as an example, setting corresponding component H₀^{k}=β_{k,3}β_{k,2}β_{k,1}xᵢ^{T}, while setting component of the main task channel of H₀¹=λβ_{k,3}β_{k,2}β_{k,1}xᵢ^{T}, and the remaining channel of 0 vector,

Thus,

$${H}_{0} = {[ \begin{matrix}… & … & … & & \\ {λβ}_{k , 3} {β}_{k , 2} {β}_{k , 1} {x}_{i}^{T} & 0 & … {β}_{k , 3} {β}_{k , 2} {β}_{k , 1} {x}_{i}^{T} & … & 0 \\ … & … & … & & \end{matrix} ]}^{T} ;$$

L_{κ}_{₀} is N₀×N₀ Laplace matrix for solving semi-supervised learning calculation problem, using adjacent data smoothness constraints as optimization targets for achieving unlabeled data to participate in the calculation of the classification surface. The calculation formula is L_{κ}_{₀}=D−W, wherein D is diagonal matrix, which element is Dᵢᵢ=Σⱼ₌₁^{m}Wᵢⱼ, Wᵢⱼ=e^{-∥x}^{ᵢ}^{-x}^{ⱼ}^{∥}^{²}^{/2δ}^{²}, xᵢ is a sample vector, and δ is an empirical value;

(III) performing iterative calculation of output matrix

When a new training data block κₖ is added, performing iterative calculation of output matrix β^{(k+1)}.

β^{(k+1)}=β^{(k)}+Pₖ₊₁Hₖ₊₁^{T}[Jₖ₊₁Tₖ₊₁−(Jₖ₊₁+λL_{κ}_{ₖ₊₁})Hₖ₊₁β^{(k)}]

Wherein

Pₖ₊₁=Pₖ−PₖHₖ₊₁^{T}(I+(Jₖ₊₁+λL_{κ}_{ₖ₊₁})Hₖ₊₁PₖHₖ₊₁^{T})⁻¹

3.2) Recognition process of the multi-task semi-supervised sequential extreme learning algorithm:

Calculating the depth feature of data to be identified x in the main task channel to obtain the output matrix H¹=λβ_{1,3}β_{1,2}β_{1,1}x^{T} of the hidden layer of the main task channel. At this time, doing not consider specific emotional bias, and thus the feature vector of the remaining channel is 0, stitching H^{k} of other sub-task channel as the output matrix H of the hidden layer, calculating category label \hat{T}=βH of x according to obtained β in the training phase to achieve judgment of the emotional polarity.

In the above solution, preferably, in the step 2), the multi-layer contraction self-coding extreme network structure and multi-task parameter training method based on multi-channel specifically includes:

the multi-task semi-supervised online sequential extreme learning network structure is mixed neural network, containing the input layer, the hidden layer and the output layer;

The input layer is independent input of multi-channel, including a main task channel and p−1 sub-task channels, wherein each channel uses output parameter β=[β₁₁ . . . βᵢⱼ . . . β_{MN}] of each layer of a published multi-layer contraction self-coding extreme network to represent the weight of the connection node between two layers;

According to contraction self-coding mechanism, the coding layer: H=G(αX+b), wherein αᵢⱼ is the element of the vector α, that is, the weight of the connection between the input layer node i and the feature layer node j, bⱼ is the element of the vector b, that is, the bias of the feature layer node; and G is a stimulus function using the sigmoid function

$$G ( z ) = \frac{1}{1 + {e}^{- z}} ,$$

x to input the vector for each layer;

According to extreme learning machine mechanism, wherein α and b are random numbers meeting optimization target condition of contraction coding, calculating the parameter β, as shown in the following formula, namely: decoding the minimum error of the predicted value Hβ and the actual value X, and first order continuity of transfer function;

β=argmin(∥Hβ−X∥₂²+λ∥J_{f}(x)∥_{F}²)

Wherein J_{f}(x) is Jacobian matrix of the transfer function of the feature layer, which calculation method is shown as follows:

$${‖ {J}_{f} ( X ) ‖}_{F}^{2} = {\sum }_{ij}^{ } {( \frac{\partial {\sum }_{k = 1}^{L} {G}_{k} ( X , {a}_{k} , {b}_{k} ) {β}_{kj}}{\partial {x}_{i}} )}^{2} ;$$

The coding layer parameters β can be obtained according to symmetry hypothesis of the coding layer and the decoding layer, and the output parameters β are calculated for each hidden layer for realizing deep feature extraction of input data of the channel, and as the input of the hidden layer in the multi-task semi-supervised online sequential extreme learning algorithm;

The hidden layer is used to connect output results of multi-channel and as input of the output layer, assuming that the k-th channel adopts three-layer hidden layer feature extraction network (the output parameter of each layer is recorded as β_{k,1},β_{k,2},β_{k,3}), the transfer function of the hidden layer of the multi-layer contraction self-coding extreme network is Hₖ=β_{k,3}β_{k,2}β_{k,1}X^{T};

The output layer is used to connect the output of the hidden layer of each channel to the output layer, which output transmission parameters are recorded as β in the multi-task semi-supervised online sequential extreme learning algorithm. The elements βᵢⱼ indicates the weight of the connection between the hidden layer node i and the output layer node j, calculating the output parameter β=H^{†}T through calculation results H of the hidden layer and sample T according to estimated minimum error and network weight regularization optimization target.

In the above solution, preferably, in the multi-task semi-supervised online sequential extreme learning method, entering a training sample data each time, only inputting data in one sub-task channel, the other sub-task channel input being taken 0, assuming that the input of the k-th sub-task is xₖ, thus the input of the main task channel is x₁=λxₖ, wherein λ is the penalty factor of the sub-task, and is in the range of (0,1).

In one embodiment of the present invention, in the multi-task semi-supervised online sequential extreme learning method for emotion judgment of user, it is preferred that the hidden layer nodes of each channel can be adjusted.

For making a better understanding of the present invention by those skilled in the art, the following embodiments are provided:

The design idea of the present invention is that multi-task learning mechanism is introduced in the single-hidden layer neural network model of extreme learning. The input layer and the hidden layer are divided into multiple channels for respectively treating main task of positive/negative emotions and subtasks of multiple emotion recognition. The multi-layer stack self-coding extreme learning network is established in each channel for feature extraction, inputting hidden layer nodes of each channel. At the output layer, each output node is connected to all hidden nodes to calculate the output. This method effectively reduces the number of input nodes connected to each hidden node, and calculation load of each hidden layer node is effectively reduced. Also, the method can adjust the number of hidden nodes of each channel, which will affect the weight of each feature, and the recognition effect is slightly improved after adjustment. Simultaneously,

Comparison of the multi-task semi-supervised online sequential extreme learning algorithm and the neural network model of the semi-supervised extreme learning:

the specific calculation process of the multi-task semi-supervised online sequential extreme learning algorithm includes the following steps:

(1) defining parameter of the multi-task semi-supervised online sequential extreme learning algorithm:

p: the number of channels, wherein channel 1 is a main task channel, and the remaining 2 . . . p are sub-task channels, representing state number of positive emotions and the negative emotions;

Xₖ=[X_{k,1}, . . . , X_{k,N}]: the input vector of the k-th channel, k=1,2, . . . , p;

N: the vector dimension of input data or test data.

T=[t₁, t₂]: the output vector expressing judgment results of positive emotions and negative emotions. Wherein: t₁=1, t₂=0, express positive emotions, and t₁=0, t₂=1, express negative emotions. For multi-task problem of a variety of emotional recognition, being equivalent to output plus bias. Namely: the output of happy, excited and other positive emotions is t₁+Δtᵣ; and the output of anger, sadness and other negative emotions is t₁+Δt_{w}. For unlabeled training data, tᵢ is filled with 0.

Hₖ=[H_{k,1} . . . H_{k,Ñ}]: the output of the hidden layer on the k-th channel, where k=1,2, . . . , p.

Ñ: hidden node number of the k-th channel.

(2) the multi-task mixed extreme learning network structure and multi-task parameter training method based on multi-channel

As shown in FIG. 2, the learning network of the algorithm provided by the present invention is mixed neural network, containing the input layer, the hidden layer and the output layer.

The input layer is independent input of multi-channel, including a main task channel and p−1 sub-task channels, wherein each channel uses the published multi-layer contraction self-coding extreme network, its structure and training process view shown in FIG. 3.

The depth contraction self-coding extreme network structure view shown on the left of FIG. 3, the output parameter β=[β₁₁ . . . βᵢⱼ . . . β_{MN}] of each layer represent the weight of the connection node between two layers. The training process view shown on the right of FIG. 3, the coding layer is H=G(αX+b) according to contraction self-coding mechanism, wherein αᵢⱼ is the element of the vector α, that is, the weight of the connection between the input layer node i and the feature layer node j in the view, bⱼ is the element of the vector b, that is, the bias of the feature layer node; and G is a stimulus function using the sigmoid function

$$G ( z ) = \frac{1}{1 + {e}^{- z}} ,$$

x to input the vector for each layer. According to extreme learning algorithm mechanism, wherein α and b are random numbers meeting optimization target condition of contraction coding, calculating the parameter β, as shown in the following formula, namely: decoding the minimum error of the predicted value Hβ and the actual value X, and first order continuity of transfer function;

β=argmin(∥Hβ−X∥₂²+λ∥J_{f}(x)∥_{F}²)

Wherein J_{f}(x) is Jacobian matrix of the transfer function of the feature layer, which calculation method is shown as follows:

$${‖ {J}_{f} ( X ) ‖}_{F}^{2} = {\sum }_{ij}^{ } {( \frac{\partial {\sum }_{k = 1}^{L} {G}_{k} ( X , {a}_{k} , {b}_{k} ) {β}_{kj}}{\partial {x}_{i}} )}^{2} ;$$

The coding layer parameters β can be obtained according to symmetry hypothesis of the coding layer and the decoding layer, and the output parameters β are calculated for each hidden layer for realizing deep feature extraction of input data of the channel, and as the input of the hidden layer of FIG. 2.

It should be noted that only sub-task channel of one channel has a value when each time you enter a training sample data in the multi-task learning mechanism, the input of other channels is taken 0. Assuming that the input of the k-th sub-task is xₖ, thus the input of the main task channel is x₁=λxₖ, wherein λ is the penalty factor of the subtask and is used to equalize contribution of the sub-task, which is the empirical value and can be adjusted in the application. The range of values is usually (0, 1). But the use of different λ will have an impact on recognition effect, and the optimal λ need to find by experiment. For different purposes, the optimal λ is different.

The hidden layer is used to connect output results of multi-channel and as input of the output layer, assuming that the k-th channel adopts three-layer hidden layer feature extraction network (the output parameter of each layer is recorded as β_{k,1},β_{k,2},β_{k,3}), the transfer function of the hidden layer of the multi-layer contraction self-coding extreme network is Hₖ=β_{k,3}β_{k,2}β_{k,1}X^{T};

The output layer is used to connect the output of the hidden layer of each channel to the output layer, as shown the bottom layer in FIG. 2, which output transmission parameters are recorded as β. Its elements βᵢⱼ indicates the weight of the connection between the hidden layer node i and the output layer node j, calculating the output parameter β=H^{†}T through calculation results H of the hidden layer and sample T according to estimated minimum error and network weight regularization optimization target.

(3) improved multi-task semi-supervised sequential extreme learning algorithm

Considering the problem of non-acquisition one time and calibration difficulty of training samples, referring to SOS-ELM. The parameter training process adopts the semi-supervised online learning method to further improve the multi-task learning algorithm for emotion judgment based on multi-channel mixed extreme learning network mentioned above. That is the training data is in batches, and each batch of training samples contains both labeled and unlabeled samples.

I. the parameter training process of the multi-task semi-supervised sequential extreme learning algorithm:

According to the SOS-ELM algorithm, the output parameter training process and the calculation method based on the continuity and hypotheticality of data, the simplest optimization target of function, and matrix block calculation method, are as follows:

(I) inputting initial training data block κ₀:

The initial training data block is κ₀={(xᵢ,tᵢ+Δtᵢ) or x′ᵢ}ᵢ₌₁^{N}^{₀}, wherein N₀ is the number of samples; xᵢ is labeled samples, which corresponding emotional label is positive and negative emotional sub-category label tᵢ plus the emotional bias Δtᵢ; and x′ᵢ is unlabeled samples, which corresponding label tᵢ is 0.

Initializing the input of the multi-channel, performing assignment in the corresponding sub-task channel according to the emotional label of each sample, if the i-th sample belongs to emotional sub-task of the k-th channel, xₖ=xᵢ, while the input of the main task channel 1 is set to x₁=λxᵢ, the input of the remaining channel is 0, and the emotional expression is tᵢ+Δtᵢ. For unlabeled date, assigning only in the main task channel, setting the input of the remaining channel to 0, and reconstructing the initial training data block κ₀={(λxᵢ . . . 0 . . . xᵢ . . . 0,tᵢ+Δtᵢ) or x′ᵢ . . . 0 . . . 0}ᵢ₌₁^{N}^{₀};

(II) parameter initialization

Calculating initial output parameter β⁽⁰⁾ in the initial training data block

β⁽⁰⁾=K₀⁻¹H₀^{T}J₀T₀

Wherein K₀=I+H₀^{T}J₀H₀L_{κ}_{₀}H₀;

Wherein I is regularization matrix.

T₀ is N₀×2, label matrix.

$${T}_{0} = [ \begin{matrix}… & … \\ ( {t}_{i} + Δ {t}_{i )} & 0 \\ … & …\end{matrix} ] ;$$

J₀ is diagonal matrix of N₀×N₀, wherein the element value of the diagonal matrix is set to the empirical parameter Cᵢ at the corresponding position having label data, otherwise 0; which is used to adjust the matrix of unbalanced training sample problem;

H₀ is the output matrix of (p*feature vector dimension)×N₀ hidden layer, merging the output of the hidden layer of all p channels. For multi-task problem, N₀ samples correspond to the depth feature of the sub-channels in the initial training data block, taking the i-th sample belonging to emotional sub-task of the k-th channel as an example, setting corresponding component H₀^{k}=β_{k,3}β_{k,2}β_{k,1}xᵢ^{T}, while setting component of the main task channel of H₀¹=λβ_{k,3}β_{k,2}β_{k,1}xᵢ^{T}, and the remaining channel of 0 vector,

Thus,

$${H}_{0} = {[ \begin{matrix}… & … & … & & \\ {λβ}_{k , 3} {β}_{k , 2} {β}_{k , 1} {x}_{i}^{T} & 0 & … {β}_{k , 3} {β}_{k , 2} {β}_{k , 1} {x}_{i}^{T} & … & 0 \\ … & … & … & & \end{matrix} ]}^{T} ;$$

L_{κ}_{₀} is N₀×N₀ Laplace matrix for solving semi-supervised learning calculation problem, using adjacent data smoothness constraints as optimization targets for achieving unlabeled data to participate in the calculation of the classification surface. The calculation formula is L_{κ}_{₀}=D−W, wherein D is diagonal matrix, which element is Dᵢᵢ=Σⱼ₌₁^{m}Wᵢⱼ, Wᵢⱼ=e^{-∥x}^{ᵢ}^{-x}^{ⱼ}^{∥}^{²}^{/2δ}^{²}, xᵢ is a sample vector, and δ is an empirical value;

(III) performing iterative calculation of output matrix

When a new training data block κₖ is added, performing iterative calculation of output matrix β^{(k+1)}.

β^{(k+1)}=β^{(k)}+Pₖ₊₁Hₖ₊₁^{T}[Jₖ₊₁Tₖ₊₁−(Jₖ₊₁+λL_{κ}_{ₖ₊₁})Hₖ₊₁β^{(k)}]

Wherein

Pₖ₊₁=Pₖ−PₖHₖ₊₁^{T}(I+(Jₖ₊₁+λL_{κ}_{ₖ₊₁})Hₖ₊₁PₖHₖ₊₁^{T})⁻¹

The other defined parameters are same as the previous section, which is obtained on the κₖ data set.

II. Recognition process of the multi-task semi-supervised sequential extreme learning algorithm:

Calculating the depth feature of data to be identified x in the main task channel to obtain the output matrix H¹=λβ_{1,3}β_{1,2}β_{1,1}x^{T} of the hidden layer of the main task channel. At this time, doing not consider specific emotional bias, and thus the feature vector of the remaining channel is 0, stitching H^{k} of other sub-task channel as the output matrix H of the hidden layer, calculating category label \hat{T}=βH of x according to obtained β (the lastest training obtains the latest β) in the training phase to achieve judgment of the emotional polarity.

As described above, the present invention provides a new machine learning algorithm-multi-task semi-supervised extreme learning algorithm. The negative and positive emotion judgment of the user is transformed into a multi-channel structure including main task for judging positive and negative emotions and sub-task for recognizing a plurality of emotion state using multi-task process mechanism, and the multi-channel structure for processing the main task and the multiple sub-tasks is established, and depth features of each channel is extracted by the stack extreme learning model (because the main task is a multi-class task, it is more difficult to fit its classification surface directly, so the task is divided into the main task and multiple sub-tasks, which is easier to fit the main task classification, and remove influence of different sub-tasks.). The output layer is fully connected to the hidden layer of each channel, and finally outputs a single output vector. The algorithm supports sequential learning, supports semi-supervised training samples, and has extremely fast training speed. The method is applied to the intelligent service robot to judge the user's emotional state, which can achieve higher recognition rate in the case of less training samples, and occupy less processor and memory resources. The algorithm is suitable for solving the problem that the labeled sample is insufficient, and the multi-source information fusing machine can be obtained in batches of labeled samples and unlabeled samples.

The multi-task semi-supervised online sequential extreme learning algorithm of the present invention is based on the SOS-ELM, carries on the multi-channel improvement, establishes the multi-channel mixed multi-task extreme learning method, and realizes fast emotion polarity recognition of the face image. For the intelligent service robot to judge the emotional state of the service object, using built-in camera to obtain the facial image of the service object, realizing emotion polarity recognition based on the facial expression, detecting the occurrence of the negative emotion, and providing the basis for taking countermeasures.

The multi-task semi-supervised online sequential extreme learning algorithm does not only inherit advantages of the original online learning of the SOS-ELM algorithm and support of semi-supervised training data , but also integrats into the depth feature extraction method, increases process ability of multi-channel input, establishes multi-task learning mechanism, effectively overcomes the influence of emotional diversity on the judgment of emotional polarity in terms of emotional polarity recognition, and improves the judgment ability of emotional polarity.

The algorithm is particularly suitable for personal emotional polarity recognition. As facial expression movements of different individuals are vary widely in the natural expression recognition, the current recognition of natural expression is more difficult, requiring a large number of labeled samples for training and recognition of the natural expression. Taking into account the intelligent service robot application scenarios, and more for the emotional state of recognition of the specific individual, performing recognition model training in a specific person data set, and having greater applicability and application requirements. However, the number of labeled training samples collected for a particular individual is relatively small, so it is difficult to achieve a higher recognition rate using only labeled samples, and the use of unlabeled samples can effectively improve recognition rate, which requires semi-supervised learning algorithm. The online learning function can effectively use the real-time accessed new expression image model for sequential learning. Multi-task semi-supervised sequential extreme learning algorithm can reduce the diversity of natural emotions to judge emotions and achieve fast and robust emotional polarity judgment. The following section describes how to use the multi-task semi-supervised sequential extreme learning algorithm in emotional polarity recognition.

According to the general method of model recognition, facial expression should include feature extraction and classification. Due to the complexity of facial images with different expressions, performing feature extraction by using the depth contraction self-coding extreme learning algorithm to obtain feature vector of the facial expression image. Corresponding feature vector and weighted feature vector are inputted respectively in the emotional sub-task channel and the main task channel for emotional polarity judgment in the training phase. The labeled expression training data should provide its output label vector. And then the labeled and unlabeled training data are inputted into the multi-task semi-supervised sequential extreme learning algorithm training. After the training is completed, the new expression image can be recognized by the input algorithm after feature vector extraction in the main task channel to obtain the output vector used as the recognition result. The new expression image can also be performed online training as a training data after feature vector extraction.

Number of modules and scale of processing described herein are intended to simplify description of the invention. The application, modification and variation of touch sensing circuit and temperature stall of the multi-task semi-supervised online sequential extreme learning method for emotion judgment of user of the present invention will be apparent to those skilled in the art.

Although the embodiments of the present invention have been disclosed above, they are not limited to the applications previously mentioned in the specification and embodiments, and can be applied in various fields suitable for the present invention. For ordinary skilled person in the field, other various changed model, formula and parameter may be easily achieved without creative work according to instruction of the present invention, changed, modified and replaced embodiments without departing the general concept defined by the claims and their equivalent are still included in the present invention. The present invention is not limited to particular details and illustrations shown and described herein.

What is claimed is:

1. A multi-task semi-supervised online sequential extreme learning method for emotion judgment of user, being characterized in that, includes:
establishing a plurality of channels at an input layer and a hidden layer based on the semi-supervised online sequential extreme learning machine, the plurality of channels including a main task channel for treating emotion main task, a plurality of sub-task channels for processing each plurality of emotion recognition sub-task for establishing multi-task semi-supervised online sequential extreme learning algorithm;
establishing multi-layer stack self-coding extreme learning network in each channel;
performing feature extraction of facial expression image on the user's expression, and inputting extracted feature vector of facial expression image to the main task channel and the corresponding sub-task channel;
connecting each output node and all hidden layers nodes on the output layer, calculating output, and determining the user's emotion, wherein the output node is set to T, T=[t₁, t₂], wherein: t₁=1, t₂=0, express positive emotions, and t₁=0, t₂=1, express negative emotions.

2. The multi-task semi-supervised online sequential extreme learning method for emotion judgment of user according to claim 1, being characterized in that, the specific calculation process of the multi-task semi-supervised online sequential extreme learning algorithm includes the following steps:
1) defining parameter of the multi-task semi-supervised online sequential extreme learning algorithm:
p: the number of channels, wherein channel 1 is main task channel, and the remaining 2 . . . p are sub-task channels, representing state number of positive emotions and the negative emotions;
Xₖ=[X_{k,1}, . . . , X_{k,N}]: the input vector of the k-th channel, k=1,2, . . . , p;
N: the vector dimension of input data or test data;
T=[t₁, t₂]: the output vector expressing judgment results of positive emotions and negative emotions, wherein: t₁=1, t₂=0, express positive emotions, and t₁=0, t₂=1, express negative emotions, for multi-task problem of a variety of emotional recognition, being equivalent to the output plus bias, for labeled training data, the output of positive emotions being t₁+Δtᵣ; output of negative emotions being t₁+Δt_{w}; and for unlabeled training data, tᵢ being filled with 0;
Hₖ=[H_{h,1} . . . H_{k,Ñ}]: the output of the hidden layer on the k-th channel, k=1,2, . . . , p;
Ñ: the hidden node number of the k-th channel;
2) a multi-task semi-supervised online sequential extreme learning network structure and multi-task parameter training method based on multi-channel, performing continuous training and calculation to obtain the output parameters β=H^{†}T using a multi-layer contraction self-coding extreme network;
3) according to said method in the step 2), performing the training data in batches using semi-supervised online learning method in the parameter training process, and each batch of training samples containing labeled training data and unlabeled training data;
3.1) the training process of the multi-task semi-supervised sequential extreme learning algorithm:
according to the SOS-ELM algorithm, the output parameter training process and the calculation method based on the continuity and hypotheticality of data, the simplest optimization target of function, and matrix block calculation method, being as follows:
(I) inputting initial training data block κ₀:
in the initial training data block κ₀={(xᵢ,tᵢ+Δtᵢ) or x′ᵢ}ᵢ₌₁^{N}^{₀}, wherein N₀ is the number of samples; xᵢ is labeled samples, which corresponding emotional label is positive and negative emotional sub-category label tᵢ plus the emotional bias Δtᵢ; and x′ᵢ is unlabeled samples, which corresponding label tᵢ is 0;
initializing the input of the multi-channel, performing assignment in the corresponding sub-task channel according to the emotional label of each sample, if the i-th sample belongs to emotional sub-task of the k-th channel, xₖ=xᵢ while the input of the main task channel 1 is set to xᵢ=λxᵢ the input of the remaining channel being 0, and the emotional expression being tᵢ+Δtᵢ, for unlabeled date, assigning only in the main task channel, setting the input of the remaining channel to 0, and reconstructing the initial training data block κ₀={(λxᵢ . . . 0 . . . xᵢ . . . 0,tᵢ+Δtᵢ) or x′ᵢ . . . 0 . . . 0}ᵢ₌₁^{N}^{₀};
(II) parameter initialization
calculating initial output parameter in the initial training data block;
β⁽⁰⁾=K₀⁻¹H₀^{T}J₀T₀;
wherein K₀=I+H₀^{T}J₀H₀L_{κ}_{₀}H₀;
wherein I is regularization matrix;
T₀ being N₀×2 label matrix.
$${T}_{0} = [ \begin{matrix}… & … \\ ( {t}_{i} + Δ {t}_{i )} & 0 \\ … & …\end{matrix} ] ;$$
J₀ being diagonal matrix of N₀×N₀, wherein the element value of the diagonal matrix is set to the empirical parameter Cᵢ at the corresponding position having label data, otherwise 0; which is used to adjust the matrix of unbalanced training sample problem;
H₀ being output matrix of (p*feature vector dimension)×N₀ hidden layer, merging output of the hidden layer of all p channels, for multi-task problem, N₀ samples corresponding to the depth feature of the sub-channels in the initial training data block, taking the i-th sample belonging to emotional sub-task of the k-th channel as an example, setting corresponding component H₀^{k}=β_{k,3}β_{k,2}β_{k,1}xᵢ^{T}, while setting component of the main task channel of H₀¹=λβ_{k,3}β_{k,2}β_{k,1}xᵢ^{T}, and the remaining channel of 0 vector,
thus,
$${H}_{0} = {[ \begin{matrix}… & … & … & & \\ {λβ}_{k , 3} {β}_{k , 2} {β}_{k , 1} {x}_{i}^{T} & 0 & … {β}_{k , 3} {β}_{k , 2} {β}_{k , 1} {x}_{i}^{T} & … & 0 \\ … & … & … & & \end{matrix} ]}^{T} ;$$
L_{κ}_{₀} being N₀×N₀ Laplace matrix for solving semi-supervised learning calculation problem, using adjacent data smoothness constraints as optimization targets for achieving unlabeled data to participate in the calculation of the classification surface, the calculation formula being L_{κ}_{₀}=D−W, wherein D is diagonal matrix, which element is Dᵢᵢ=Σᵢ₌₁^{m}Wᵢⱼ, Wᵢⱼ=e^{-∥x}^{ᵢ}^{-x}^{ⱼ}^{∥}^{²}^{/2δ}^{²}, xᵢ is a sample vector, and δ is an empirical value;
(III) performing iterative calculation of output matrix;
when new training data block κₖ is added, performing iterative calculation of output matrix β^{(k+1)};
β^{(k+1)}=β^{(k)}+Pₖ₊₁Hₖ₊₁^{T}[Jₖ₊₁Tₖ₊₁−(Jₖ₊₁+λL_{κ}_{ₖ₊₁})Hₖ₊₁β^{(k)}];
wherein Pₖ₊₁=Pₖ−PₖHₖ₊₁^{T}(I+(Jₖ₊₁+λL_{κ}_{ₖ₊₁})Hₖ₊₁PₖHₖ₊₁^{T})⁻¹;
3.2) recognition process of the multi-task semi-supervised sequential extreme learning algorithm:
calculating the depth feature of data to be identified in the main task channel to obtain the output matrix H¹=λβ_{1,3}β_{1,2}β_{1,1}x^{T} of the hidden layer of the main task channel, at this time, doing not consider specific emotional bias, and thus the feature vector of the remaining channel being 0, stitching together H^{k} of other sub-task channel as the output matrix H of the hidden layer, calculating category label \hat{T}=βH of x according to obtained β in the training phase to achieve judgment of the emotional polarity.

3. The multi-task semi-supervised online sequential extreme learning method for emotion judgment of user according to claim 2, being characterized in that, in the step 2), the multi-layer contraction self-coding extreme network structure and multi-task parameter training method based on multi-channel specifically includes that: the multi-task semi-supervised online sequential extreme learning network structure is mixed neural network, containing the input layer, the hidden layer and the output layer;
wherein the input layer is independent input of multi-channel, including a main task channel and p−1 sub-task channels, wherein each channel uses output parameter β=[β₁₁ . . . βᵢⱼ . . . β_{MN}] of each layer of a published multi-layer contraction self-coding extreme network to represent the weight of the connection node between two layers;
according to the contraction self-coding mechanism, the coding layer: H=G(αX+b), wherein αᵢⱼ is the element of the vector α, that is, the weight of the connection between the input layer node i and the feature layer node j, bⱼ is the element of the vector b, that is, the bias of the feature layer node; and G is a stimulus function using the sigmoid function
$$G ( z ) = \frac{1}{1 + {e}^{- z}} x$$
to input the vector for each layer;
according to extreme learning machine mechanism, wherein α and b are random numbers meeting optimization target condition of contraction coding, calculating the parameter β, as shown in the following formula, namely: decoding the minimum error of the predicted value Hβ and the actual value X, and first order continuity of transfer function;
β=argmin(∥Hβ−X∥₂²+λ∥J_{f}(x)∥_{F}²);
wherein J_{f}(x) is Jacobian matrix of the transfer function of the feature layer, which calculation method is shown as follows:
$${‖ {J}_{f} ( X ) ‖}_{F}^{2} = {\sum }_{ij}^{ } {( \frac{\partial {\sum }_{k = 1}^{L} {G}_{k} ( X , {a}_{k} , {b}_{k} ) {β}_{kj}}{\partial {x}_{i}} )}^{2} ;$$
capable of obtaining the coding layer parameters β according to symmetry hypothesis of the coding layer and the decoding layer, and calculating the output parameters β for each hidden layer for realizing deep feature extraction of input data of the channel, and as the input of the hidden layer in the multi-task semi-supervised online sequential extreme learning algorithm;
the hidden layer being used to connect output results of multi-channel and as the input of the output layer, assuming that the k-th channel adopts three-layer hidden layer feature extraction network, the output parameter of each layer being recorded as β_{k,1},β_{k,2},β_{k,3}, the transfer function of the hidden layer of the multi-layer contraction self-coding extreme network being Hₖ=β_{k,3}β_{k,2}β_{k,1}x^{T};
the output layer being used to connect the output of the hidden layer of each channel to the output layer, which output transmission parameters are recorded as β in the multi-task semi-supervised online sequential extreme learning algorithm, the elements βᵢⱼ expressing the weight of the connection between the hidden layer node i and the output layer node j, calculating the output parameter β=H^{†}T through calculation results H of the hidden layer and sample T according to estimated minimum error and network weight regularization optimization target.

4. The multi-task semi-supervised online sequential extreme learning method for emotion judgment of user according to claim 3, being characterized in that, in the multi-task semi-supervised online sequential extreme learning method, entering a training sample data each time, only inputting data in one sub-task channel, the other sub-task channel input being taken 0, assuming that the input of the k-th sub-task is xₖ, thus the input of the main task channel is x₁=λxₖ, wherein λ is the penalty factor of the sub-task, and is in the range of (0,1).

5. The multi-task semi-supervised online sequential extreme learning method for emotion judgment of user according to claim 1, being characterized in that, hidden layer nodes of each channel can be adjusted.
